(19) United States
(12) Patent Application Publication
(10) Pub. No.: US 2016/0105107 A1
(43) Pub. Date: Apr. 14, 2016

(54) APPARATUS AND METHOD OF PULSE WIDTH MODULATION WITH FEEDBACK CONTROL

(71) Applicant: SAVITECH CORP., Zhubei City (TW)

(72) Inventors: Horng-Der CHANG, Zhubei City (TW); Chi-Chien CHEN, Zhubei City (TW)

(73) Assignee: SAVITECH CORP., Zhubei City (TW)

(21) Appl. No.: 14/511,048

(22) Filed: Oct. 9, 2014

(51) Int. Cl. H02M 3/158

(52) U.S. Cl. CPC H02M 3/158

(57) ABSTRACT

According to one embodiment an apparatus of pulse width modulation with feedback control, adapted to drive an external load, the apparatus comprising a pulse width modulator, an adjustment encoder, a power driver, and a controller, wherein the pulse width modulator transfers a pulse code modulation code into a pulse width modulation code, the adjustment encoder transfers the pulse width modulation code into an upper-driven signal and a lower-driven signal, the power driver receives the upper-driven signal and the lower-driven signal to drive the external load, the controller measures the voltage of the external load to generate a control signal according to the upper-driven signal and the lower-driven signal, and transmits the control signal to the adjustment encoder to adjust the upper-driven signal and the lower-driven signal.

### TECHNICAL FIELD

The technical field generally relates to an apparatus and method of pulse width modulation with feedback control.

### BACKGROUND

In the past, the analog audio playback was often used in radio, television to directly drive speaker with analog signal. With the advancement of technology, the evolution of PC and network, and the development of digital audio signal processing, the digital audio player has been widely used in various electronic systems such as audio speakers in cinemas, home, and car, and digital television, computers, music players, and mobile phones. The functionality for audio signal processing must feature with low noise and high-quality, in order to make sound effect more complete and reduce human machine interface error rate in some applications.

Some audio signal driving techniques use digital signal processing to improve the distortion and noise interference of the front-end audio signal. As shown in FIG. 1, a technology uses digital interface to organize input digital audio data of various interface specifications(such as I2S/SPDIF interface) to output pulse code modulation (PCM) code, for example, a 24-bit pulse code modulation code; then the pulse code modulation code is passed through an up-sampling and delta-sigma modulator to generate another pulse code modulation code (PCM-10 bit), then this PCM code is converted to a pulse width modulation code for power driver, such as class D amplifier driving an external load.

The above mentioned method of using pulse width modulation code for driving external load often results in distortion due to asymmetry rise/fall time of driving waveform, impedance mismatch of upper driving transistor and lower driving transistor, and voltage level mismatch of upper voltage source and lower voltage source for driving the external load. Therefore, in the architecture design of audio signal driving, how to design a technique for improving distortion of driving audio signal is needed. The present disclosure provides technique of pulse width modulation with feedback control in order to further improve the distortion of audio signal driving.

### SUMMARY

The exemplary embodiments of the disclosure may provide apparatus and method of pulse width modulation with feedback control.

One exemplary embodiment relates to an apparatus of pulse width modulation with feedback control, adapted to drive an external load, the apparatus comprising a pulse width modulator, an adjustment encoder, a power driver, and a controller, wherein the pulse width modulator transfers a pulse code modulation code into a pulse width modulation code, the adjustment encoder transfers the pulse width modulation code into an upper-driven signal and a lower-driven signal, the power driver receives the upper-driven signal and the lower-driven signal to drive the external load, the controller measures the voltage of the external load to generate a control signal according to the upper-driven signal and the lower-driven signal, and transmits the control signal to the adjustment encoder to adjust the upper-driven signal and the lower-driven signal.

Another exemplary embodiment relates to a method of pulse width modulation with feedback control, adapted to drive an external load, the method comprising: using a pulse width modulator to transfer a pulse code modulation code into a pulse width modulation code, using an adjustment encoder to transfer the pulse width modulation code into an upper-driven signal and a lower-driven signal, using a power driver to receive the upper-driven signal and the lower-driven signal to drive the external load, a controller measures the voltage of the external load and generates a control signal according to the upper-driven signal and the lower-driven signal, and the controller transmits the control signal to the adjustment encoder to adjust the upper-driven signal and the lower-driven signal.

The foregoing will become better understood from a careful reading of a detailed description provided herein below with appropriate reference to the accompanying drawings.

### BRIEF DESCRIPTION OF THE DRAWINGS

The embodiments can be understood in more detail by reading the subsequent detailed description in conjunction with the examples and references made to the accompanying drawings, wherein:

FIG. 1 illustrates an audio signal driving technology of using digital signal processing technology;

FIG. 2 illustrates an apparatus of pulse width modulation with feedback control, according to an exemplary embodiment;

FIG. 3 illustrates the pulse width modulator in FIG. 2, according to an exemplary embodiment;

FIG. 4 illustrates waveforms of the upper-driven signal and the lower-driven signal, according to an exemplary embodiment;

FIG. 5 illustrates the power driver receives the upper-driven and the lower-driven signal to drive an external load, according to an exemplary embodiment;

FIG. 6 illustrates the controller measures the voltage of the external load to generate a control signal, according to an exemplary embodiment;

FIGS. 7a and 7b illustrate control signals generated by the controller, according to an exemplary embodiment;

FIG. 8 illustrates a method of pulse width modulation with feedback control, according to an exemplary embodiment.

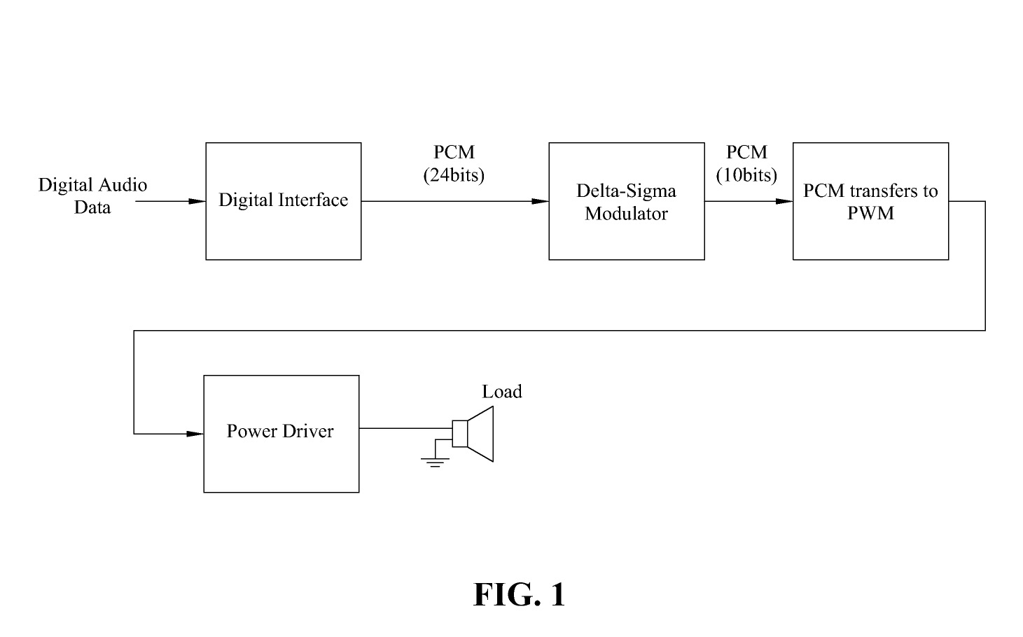

### DETAILED DESCRIPTION OF THE DISCLOSED EMBODIMENTS

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

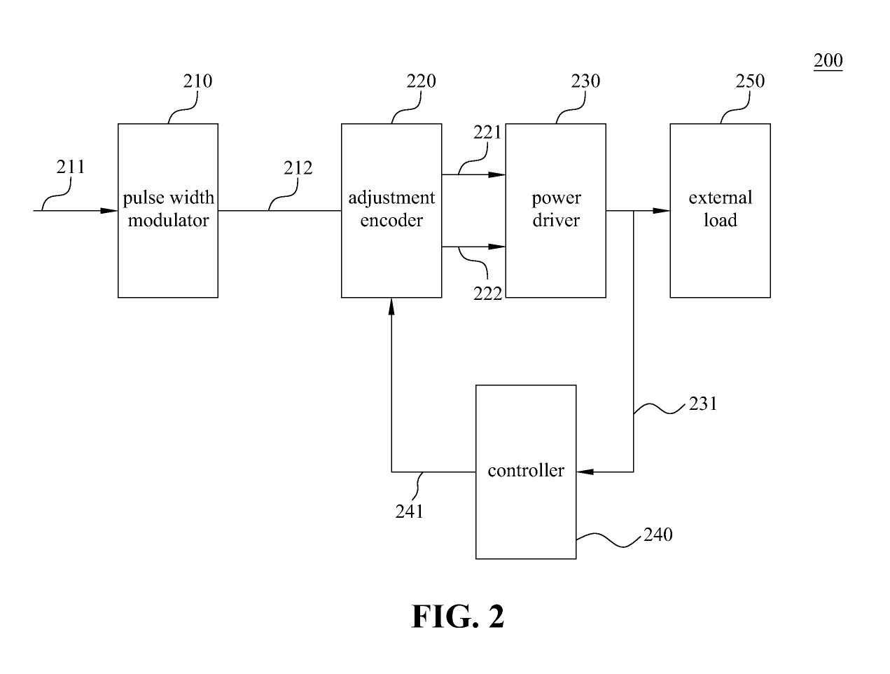

The exemplary embodiments in the disclosure may provide a technology of pulse width modulation with feedback control to improve the distortion for audio signal driving. FIG. 2 illustrates an apparatus of pulse width modulation with feedback control, according to an exemplary embodiment.

In FIG. 2, the apparatus of pulse width modulation with feedback control is applied to drive an external load. As shown in FIG. 2, the apparatus 200 includes a pulse width modulator 210, an adjustment encoder 220, a power driver 230, and a controller 240, wherein the pulse width modulator 210 transfers a pulse code modulation code 211 into a pulse width modulation code 212, the adjustment encoder 220 transfers the pulse width modulation code 212 into an upper-driven signal 221 and a lower-driven signal 222, the power driver 230 receives the upper-driven signal 221 and the lower-driven signal 222 to drive the external load 250, the controller 240 measures the voltage 231 of the external load to generate a control signal 241 according to the upper-driven signal and the lower-driven signal, and transmits the control signal 241 to the adjustment encoder 220 to adjust the upper-driven signal 221 and the lower-driven signal 222.

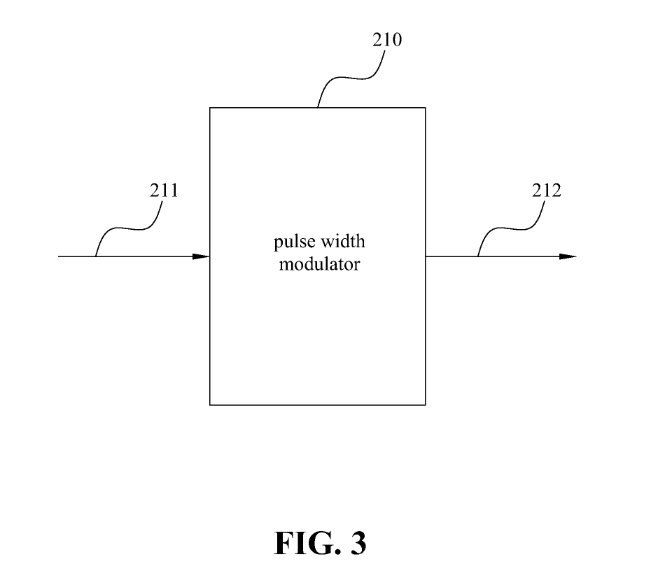

According to the apparatus of pulse width modulation with feedback control in FIG. 2, the pulse width modulator transfers the input of a pulse code modulation code 211 into a pulse width modulation code 212. FIG. 3 illustrates the pulse width modulator in FIG. 2, according to an exemplary embodiment. As shown in FIG.3, the pulse width modulator may be, for example, but not limited to a counter, performs clock counting for an inputted pulse code modulation code 211 according to a system clock, to form a pulse width modulation code 212 with pulse width proportional to the counted clocks.

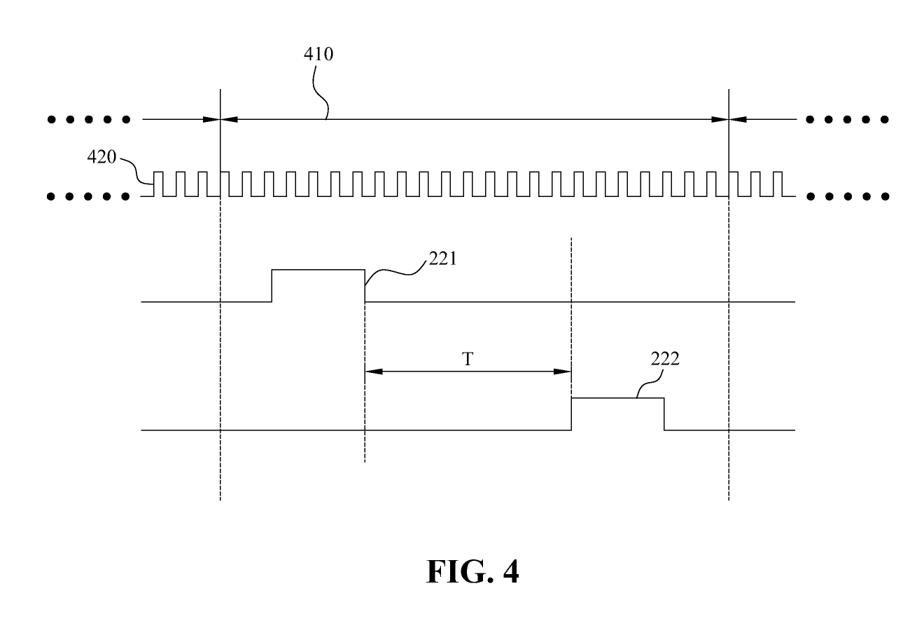

According to the apparatus of pulse width modulation with feedback control in FIG. 2, the adjustment encoder 220 transfers the pulse width modulation code 212 into an upper-driven signal 221 and a lower-driven signal 222. FIG. 4 illustrates waveforms of the upper-driven signal and the lower-driven signal, according to an exemplary embodiment. As shown in FIG. 4, in a pulse width modulation cycle 410, the adjustment encoder transfers the pulse width modulation signal into the upper-driven signal 221 and the lower-driven signal 222 based on a system clock 420. In FIG. 4, the pulse width of the upper-driven signal 221 corresponds to the pulse width modulation code, and a spare time T exists between the upper-driven signal 221 and the lower-driven signal 222. The beginning of the lower-driven signal 222 is behind of the spare time T, the ending of the lower-driven signal 222 is ahead of the ending of the pulse width modulation cycle 410.

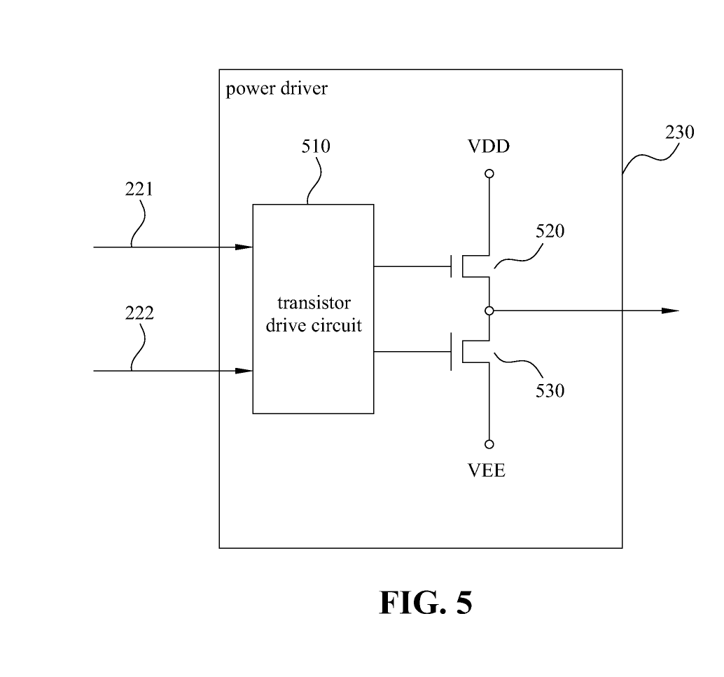

As mentioned before, the power driver 230 receives the upper-driven signal 221 and the lower-driven signal 222 to drive the external load 250. FIG. 5 illustrates the power driver 230 receives the upper 221 and lower-driven signal 222 to drive an external load 250, according to an exemplary embodiment. As shown in FIG. 5, the power driver 230 includes a transistor drive circuit 510 receiving the received upper-driven signal 221 and lower-driven signal 222 via an upper transistor 520 and a lower transistor 530 to drive the external load 250. As shown in FIG. 5, the upper transistor 520 and the lower transistor 530 connects in series with a positive power supply VDD and a negative power supply VEE, wherein the positive power supply VDD such as is +100 volts, and the negative power supply VEE such as is −100 volts. The upper transistor 520 and the lower transistor 530, for example, are implemented by metal-oxide-semiconductor (MOS) device.

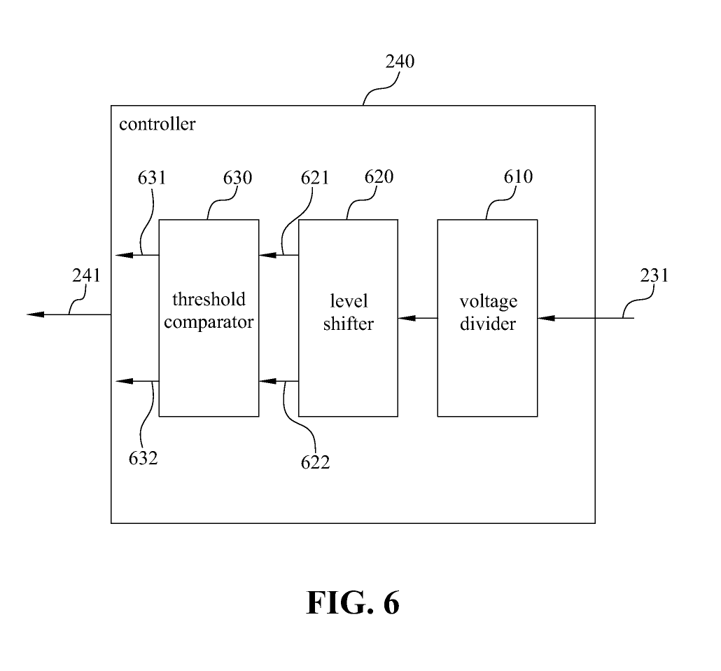

Following the above, the controller 240 measures the voltage of the external load 250 to generate a control signal 241. FIG. 6 illustrates the controller measures the voltage of the external load to generate the control signal, according to an exemplary embodiment. Refer to FIG. 6, the controller 240 comprises a voltage divider 610 and a level shifter 620 to convert the voltage 231 of the external load 250 into an upper amplitude signal 621 and a lower amplitude signal 622, as shown in FIG. 6. The controller 240 may further comprise a threshold comparator 630 to trim the upper amplitude signal 621 and the lower amplitude signal 622 into an upper delay signal 631 and a lower delay signal 632, respectively.

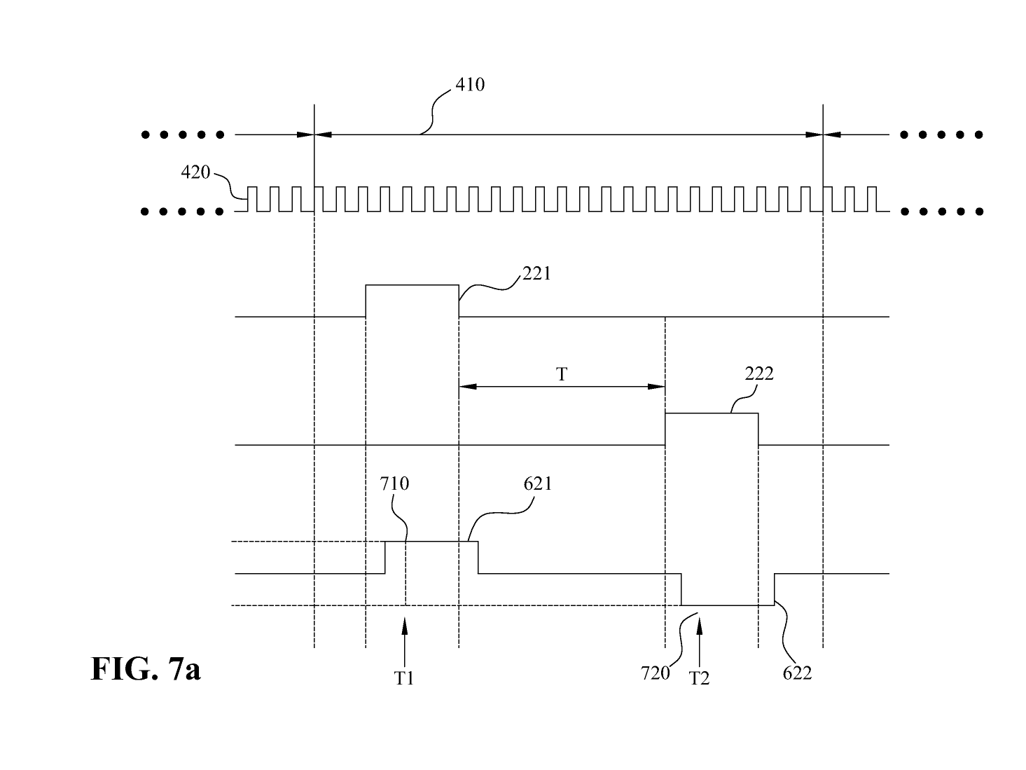

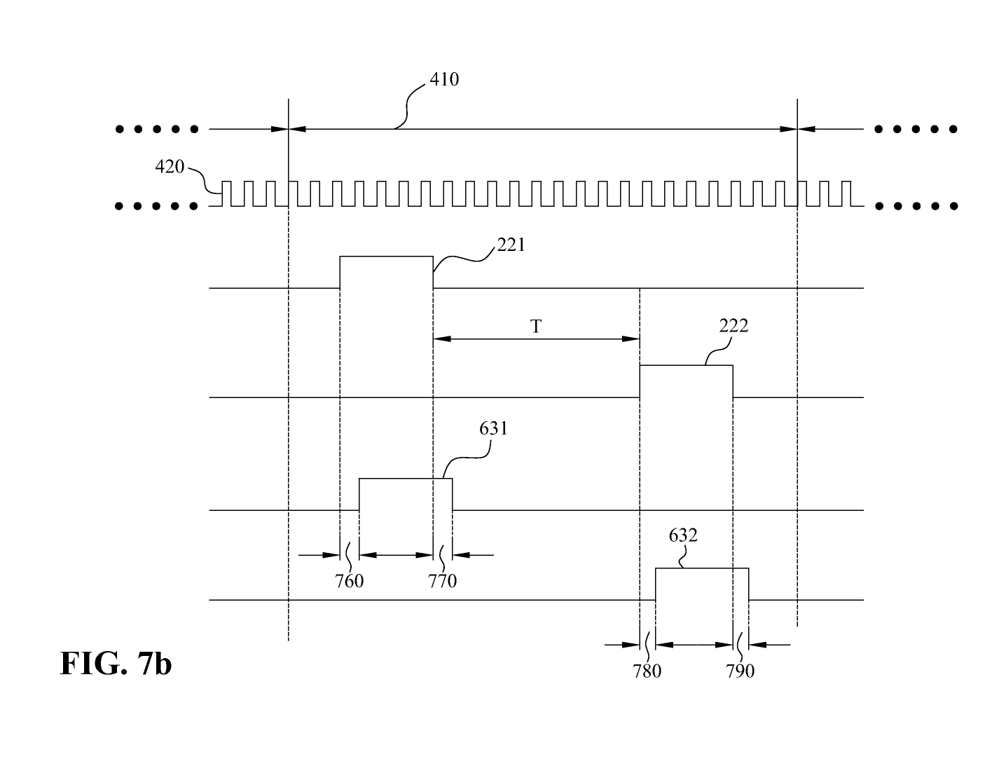

FIGS. 7a and 7b illustrate the control signals 241 generated by the controller 240, according to an exemplary embodiment. Reference to FIG. 7a, the controller measures the amplitudes of the upper amplitude signal 621 and the lower amplitude signal 622. As shown in FIG. 7a, the controller measures the amplitude of the upper amplitude signal 621 at the timing T1 to obtain an upper amplitude voltage 710. The controller also measures the amplitude of the lower amplitude signal 622 at the timing T2 to obtain a lower amplitude voltage 720, wherein the lower amplitude voltage 720 is a negative voltage value. The controller may compare the upper amplitude voltage 710 and the lower amplitude voltage 720 to generate the control signal 241. For example, the upper amplitude voltage 710 is 3 millivolts (mV) greater than the absolute value of the lower amplitude voltage 720, then the controller may transmit the control signal +3 millivolts (mV) to the adjustment encoder to adjust the upper-driven signal, i.e., the adjustment encoder reduces the pulse width of subsequent upper-driven signal by 3 microseconds (corresponding to +3 mV); or the adjustment encoder adjusts the lower-driven signal, i.e., the adjustment encodes increases the pulse width of subsequent lower-driven signal by 3 microseconds (corresponding to +3 mV).

Following the above, the controller 240 may also generate the control signal 241 based on the upper-driven signal 221 and the lower-driven signal 222. FIG. 7b shows the generated control signal based on the upper-driven signal and the lower-driven signal. Refer to FIG. 7b, the controller 710 compares the timing of the upper delay signal 631 and the upper-driven signal 221, and compares the timing of the lower delay signal 632 and end of the lower-driven signal 222. As shown in FIG. 7b, the comparison results in the upper rise delay time 760 and the upper fall delay time 770, and the lower rise delay time 780 and the lower fall delay time 790, respectively. Then the controller may compare the upper rise delay time 760 and the upper fall delay time 770, and may compare the lower rise delay time 780 and the lower fall delay time 790 to generate the control signal 241. For example, the upper rise delay time is 1 microsecond (μs) greater than the upper fall delay time, the controller may transmit the control signal +1 microseconds (μs) to the adjustment encoder to adjust the upper-driven signal, i.e., increase the pulse width of subsequent upper-driven signal by 1 microsecond. Another example is that the lower rise delay time is 2 microseconds (μs) less than the lower fall delay time, the controller may transmit the control signals −2 microseconds (μs) to the adjustment encoder to adjust the lower-driven signal, i.e., reduce the pulse width of subsequent lower-driven signal by 2 microseconds.

According to an exemplary embodiment, the controller may further comprise a memory for storing the control signal in FIG. 7a and FIG. 7b, or a plurality of control signals obtained during a period of time (i.e., a plurality of pulse width modulation cycles). The controller may also perform statistical average of the plurality of control signals, and then transmit the averaged control signal to the adjustment encoder to adjust subsequent upper-driven signal and subsequent lower-driven signal.

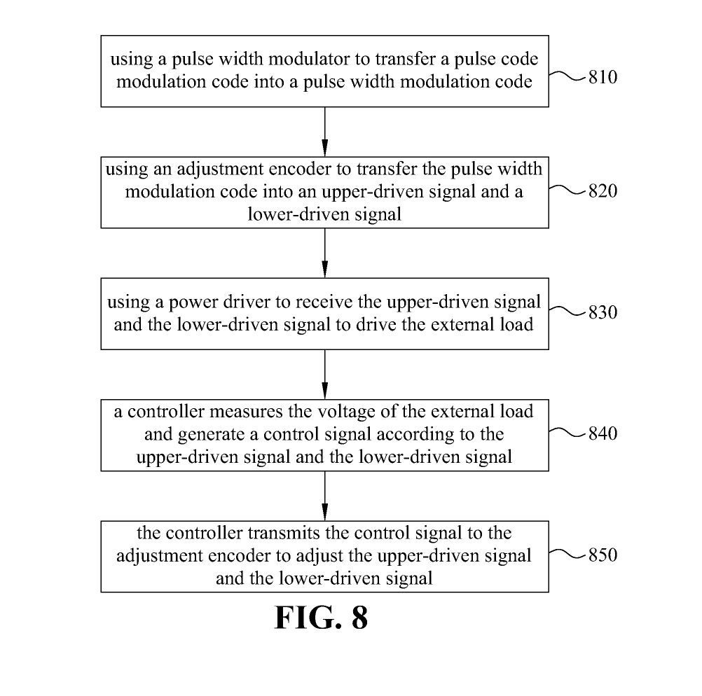

According to another exemplary embodiment, FIG. 8 illustrates a method of pulse width modulation with feedback control, adapted to drive an external load. This method comprises: using a pulse width modulator to transfer a pulse code modulation code into a pulse width modulation code (step 810); using an adjustment encoder to transfer the pulse width modulation code into an upper-driven signal and a lower-driven signal (step 820); using a power driver to receive the upper-driven signal and the lower-driven signal to drive the external load (step 830); a controller measures the voltage of the external load and generates a control signal according to the upper-driven signal and the lower-driven signal (step 840); and the controller transmits the control signal to the adjustment encoder to adjust the upper-driven signal and the lower-driven signal (step 850).

As described above, in the method of FIG. 8, the pulse width of the upper-driven signal corresponds to the pulse width modulation code, and a spare time T exists between the upper-driven signal and the lower-driven signal. The beginning of the lower-driven signal is behind of the spare time T, the ending of the lower-driven signal is ahead of the ending of the pulse width modulation cycle. The power driver includes a transistor drive circuit receiving the upper-driven signal and lower-driven signal via an upper transistor and a lower transistor to drive the external load, wherein the upper transistor and the lower transistor series with a positive power supply VDD and a negative power supply VEE, wherein the positive power supply VDD such as is +100 volts, and the negative power supply VEE such as is −100 volts. And the upper transistor and the lower transistor, for example, are implemented by metal-oxide-semiconductor (MOS) device.

In FIG. 8, the controller may measure the voltage of the external load to convert the voltage into an upper amplitude signal and a lower amplitude signal. The controller may trim the upper amplitude signal and the lower amplitude signal into an upper delay signal and a lower delay signal, respectively, compare the timing of the upper delay signal and the upper-driven signal, and compare the timing of the lower delay signal and the lower-driven signal, thus to result in the upper rise delay time and the upper fall delay time, and the lower rise delay time and the lower fall delay time, respectively. Then the controller may compare the upper rise delay time and the upper fall delay time, also may compare the lower rise delay time and the lower fall delay time to generate the control signal.

According to an exemplary embodiment, the controller may further store the control signal or a plurality of control signals obtained during a period of time. The controller may also perform statistical average of the plurality of control signals, and then transmit the averaged control signal to the adjustment encoder to adjust subsequent upper-driven signal and subsequent lower-driven signal.

In summary, the exemplary embodiment of the present disclosure provides a technology of pulse width modulation with feedback control to improve the distortion of audio signal driving.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An apparatus of pulse width modulation with feedback control, adapted to drive an external load, the apparatus comprising:
a pulse width modulator, transfers a pulse code modulation code into a pulse width modulation code;
an adjustment encoder, transfers said pulse width modulation code into an upper-driven signal and a lower-driven signal;
a power driver, receives said upper-driven signal and said lower-driven signal to drive said external load; and
a controller, measures the voltage of said external load to generate a control signal according to said upper-driven signal and said lower-driven signal, and transmits said control signal to said adjustment encoder to adjust said upper-driven signal and said lower-driven signal.

2. The apparatus as claimed in claim 1, wherein the pulse width of said upper-driven signal corresponds to said pulse width modulation code, and a spare time exists between said upper-driven signal and said lower-driven signal. The beginning of said lower-driven signal is behind of said spare time, the ending of said lower-driven signal is ahead of the ending of a pulse width modulation cycle.

3. The apparatus as claimed in claim 1, wherein said power driver includes a transistor drive circuit receiving said upper-driven signal and said lower-driven signal via an upper transistor and a lower transistor to drive said external load.

4. The apparatus as claimed in claim 3, wherein said upper transistor and said lower transistor connects in series with a positive and a negative power supply to drive said external load.

5. The apparatus as claimed in claim 3, wherein said upper transistor and said lower transistor are implemented by metal-oxide-semiconductor device.

6. The apparatus as claimed in claim 1, wherein said controller converts said voltage of said external load into an upper amplitude signal and a lower amplitude signal, and compares said upper amplitude signal and said lower amplitude signal to generate said control signal.

7. The apparatus as claimed in claim 6, wherein said controller trims said upper amplitude signal and said lower amplitude signal into an upper delay signal and a lower delay signal, respectively, to generate said control signal.

8. The apparatus as claimed in claim 7, wherein said controller compares the timing of said upper delay signal and said upper-driven signal, and compares the timing of said lower delay signal and said lower-driven signal, to obtain an upper rise delay time and a upper fall delay time, and a lower rise delay time and a lower fall delay time, respectively. Then said controller compares said upper rise delay time and said upper fall delay time, and compares said lower rise delay time and said lower fall delay time to generate said control signal.

9. A method of pulse width modulation with feedback control, adapted to drive an external load, the method comprising;
using a pulse width modulator to transfer a pulse code modulation code into a pulse width modulation code;
using an adjustment encoder to transfer said pulse width modulation code into an upper-driven signal and a lower-driven signal;
using a power driver to receive said upper-driven signal and said lower-driven signal to drive said external load;
a controller measures the voltage of said external load and generates a control signal according to said upper-driven signal and said lower-driven signal; and
said controller transmits said control signal to said adjustment encoder to adjust said upper-driven signal and said lower-driven signal.

10. The method as claimed in claim 9, wherein the pulse width of said upper-driven signal corresponds to said pulse width modulation code, and a spare time exists between said upper-driven signal and said lower-driven signal. The beginning of said lower-driven signal is behind of said spare time, the ending of said lower-driven signal is ahead of the ending of a pulse width modulation cycle.

11. The method as claimed in claim 9, wherein said power driver includes a transistor drive circuit receiving said upper-driven signal and said lower-driven signal via an upper transistor and a lower transistor to drive said external load.

12. The method as claimed in claim 11, wherein said upper transistor and said lower transistor connects in series with a positive and a negative power supply to drive said external load.

13. The method as claimed in claim 11, wherein said upper transistor and said lower transistor are implemented by metal-oxide-semiconductor device.

14. The method as claimed in claim 9, wherein said controller converts said voltage of said external load into an upper amplitude signal and a lower amplitude signal, and compares said upper amplitude signal and said lower amplitude signal to generate said control signal.

15. The method as claimed in claim 14, wherein said controller trims said upper amplitude signal and said lower amplitude signal into an upper delay signal and a lower delay signal, respectively, to generate said control signal. gnal.

16. The method as claimed in claim 15, wherein said controller compares the timing of said upper delay signal and said upper-driven signal, and compares the timing of said lower delay signal and said lower-driven signal, to obtain an upper rise delay time and an upper fall delay time, and a lower rise delay time and a lower fall delay time, respectively. Then said controller compares said upper rise delay time and said upper fall delay time, and compares said lower rise delay time and said lower fall delay time to generate said control signal
